(19) United States
(12) Patent Application Publication
(10) Pub. No.: US 2018/0159342 A1
(43) Pub. Date: Jun. 7, 2018

(54) ELECTRONIC DEVICE AND METHOD FOR CONTROLLING BATTERY OF THE ELECTRONIC DEVICE TO CHARGE AND DISCHARGE

(71) Applicant: HON HAI PRECISION INDUSTRY CO., LTD., New Taipei (TW)

(72) Inventors: TSUNG-LIEN CHEN, New Taipei (TW); HSU-MIN KUO, New Taipei (TW)

(21) Appl. No.: 15/729,675

(22) Filed: Oct. 11, 2017

(30) Foreign Application Priority Data
Dec. 2, 2016 (CN) 201611095476.3

(51) Int. Cl. H02J 7/00

(52) U.S. Cl. CPC H02J 7/007; H02J 7/0021

(57) ABSTRACT

A method for controlling a battery to charge or discharge includes detecting a usage pattern of the electronic device. The battery includes a first battery and a second battery. A state-of-charge (SOC) value of the fist battery and a SOC value of the second battery are acquired, and a processor of the electronic device can control the first battery and/or the second battery to charge and discharge the electronic device according to the usage pattern and the SOC value.

### CROSS-REFERENCE TO RELATED APPLICATIONS

This application claims priority to Chinese Patent Application No. 201611095476.3 filed on Dec. 2, 2016, the contents of which are incorporated by reference herein.

### FIELD

The subject matter herein generally relates to power management field, and particularly to an electronic device and a method for controlling the electronic device to charge and discharge.

### BACKGROUND

An electronic device (e.g., a smart phone) has low battery indicators. A charge-discharge rate of a battery of the electronic device may less than 2C (Capacity). Thus, it may take a long time to charge the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of one exemplary embodiment of electronic device.

FIG. 2 is a block diagram of one exemplary embodiment of the electronic device of FIG. 1 including a controlling system.

FIG. 3 illustrates a flow chart of an exemplary embodiment of a method for controlling a battery of the electronic device of FIG. 1 to charge and discharge.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

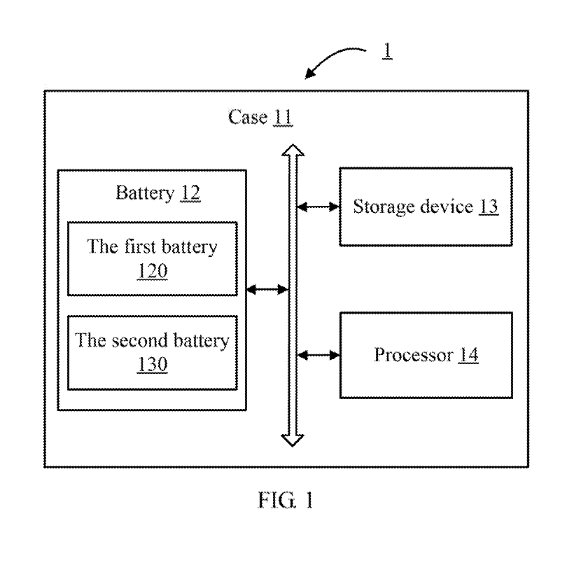

FIG. 1 is a block diagram of one embodiment of the electronic device 1. Depending on the embodiment, the electronic device 1 can include, but is not limited to, a case 11, a battery 12, a storage device 13, and at least one processor 14. The storage device 13, and the at least one processor 14 are set inside the case 11. The battery 12, the storage device 13, and the at least one processor 14 can communicate with each other through a system bus. In at least one embodiment, the electronic device 1 can be a smart phone, a tablet computer, a personal digital assistant, or any other suitable device with self-stored power supply. FIG. 1 illustrates only one example of the electronic device 1 that can include more or fewer components than illustrated, or have a different configuration of the various components in other embodiments.

In at least one exemplary embodiment, the battery 12 can include a first battery 120 and a second battery 130. The first battery 120 can be in the case 11. The second battery 130 can be in the case 11, and can attach to the case 11 via a data interface (e.g., a USB interface). The first battery 120 is slowly rechargeable as normal, and the second battery 130 is rechargeable rapidly. For example, the first battery 120 can be lithium-cobalt batteries or lithium-manganese batteries, and the second battery 130 can be lithium-ion ferrous phosphate batteries. A charge-discharge rate of the first battery 120 is less than 2C when the electronic device 1 is charging. A charge-discharge rate of the second battery 130 is more than or equal to 2C when the electronic device 1 is charging. The alphabet “C” represents charge/discharge ability of the battery 12. It is a multiple between a charge/discharge current of the battery 12 and a capacity of the battery 12.

In at least one exemplary embodiment, the storage device 13 can be a memory device of the electronic device 1. In other exemplary embodiments, the storage device 13 can be a secure digital card, or other external storage device such as a smart media card. In at least one exemplary embodiment, the storage device 13 can store a controlling system 10 of the electronic device 1. The controlling system 10 can detect a usage pattern of the electronic device 1 and status of the battery 12, and control the battery 12 to charge or recharge according to the detected usage pattern and information as to status.

In at least one exemplary embodiment, the at least one processor 14 can be a central processing unit (CPU), a microprocessor, or other data processor chip that performs functions of the electronic device 1.

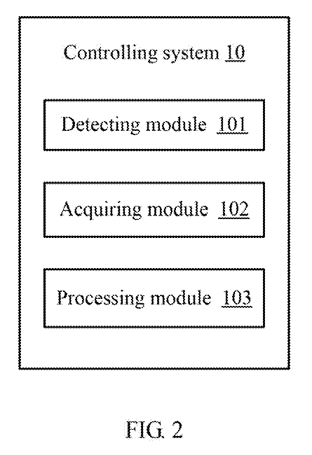

FIG. 2 is a block diagram of one embodiment of modules of a controlling system of the electronic device 1. In at least one exemplary embodiment, the controlling system 10 can include a detecting module 101, an acquiring module 102, and a processing module 103. The modules 101-103 include computerized codes in the form of one or more programs that may be stored in the storage device 13. The computerized codes include instructions that can be executed by the at least one processor 14.

In at least one exemplary embodiment, the detecting module 101 can detect usage patterns of the electronic device 1. The usage patterns can include a first usage pattern, a second usage pattern, a third usage pattern, a fourth usage pattern, and a fifth usage pattern. The controlling system 10 can apply different working mode to power the electronic device 1 by the first battery 120 and the second battery 130 when the electronic device 1 is in different usage patterns. The working modes can include a balanced mode, an optimum service life mode, a maximum capacity mode, a high output power mode, and a quick charging mode.

In at least one exemplary embodiment, in the first usage pattern, a usage rate of the electronic device 1 executes an energy-intensive application (e.g., playing video or games) is more than a first predetermined value. In the second usage pattern, duration of the electronic device 1 in sleep mode is for longer than a predetermined time (e.g., 16 hours). In the third usage pattern, the usage rate of the electronic device 1 in work mode is more than a second predetermined value. In the fourth usage pattern, a remaining power of the battery 12 of the electronic device 1 is less than a predetermined minimum value. In the fifth usage pattern, the remaining power of the battery 12 of the electronic device 1 is less than the predetermined minimum value and the electronic device 1 requires electricity in a short time period.

In at least one exemplary embodiment, the acquiring module 102 can acquire the status of the battery 12. Information as to status includes a state-of-charge (SOC) value of the first battery 120 and a SOC value of the second battery 130. The acquiring module 102 can acquire information as to the status from a sensor in the electronic device 1.

In at least one exemplary embodiment, the processing module 103 can change the working mode of the battery 12 according to the usage pattern and the status.

In at least one exemplary embodiment, the processing module 103 can apply the balanced mode to control the battery 12 to charge or discharge when the electronic device 1 is in the first usage pattern. For example, the processing module 103 can switch on charge function of the first battery 120 and switch on discharge function of the second battery 130 when the SOC value of the first battery 120 is less than the SOC value of the second battery 130. The processing module 103 can switch on discharge function of the first battery 120 and switch on charge function of the second battery 130 when the SOC value of the first battery 120 is equal to or more than the SOC value of the second battery 130. The balanced mode of the electronic device 1 can balance the quantity of remaining electricity between the first battery 120 and the second battery 130, and further can decrease a discharge rate of the first battery 120 or the second battery 130 with a high output power. It can supply 20°˜30% of electricity of the battery 12 for the electronic device 1 in a short time period when the processing module 103 controls the second battery 130 to charge in the balance mode.

In at least one exemplary embodiment, the processing module 103 can apply the optimum service life mode to control the battery 12 charge or discharge when the electronic device is in the second usage pattern. For example, the processing module 103 can switch on the charge function of the first battery 120 and the second battery 130 or switch on the discharge function of the first battery 120 and the second battery 130 at the same time. The optimum service life mode of the electronic device 1 can decrease the discharge rate of the first battery 120 or the second battery 130 with a low output power. It can supply 10%˜30% of electricity of the battery 12 for the electronic device 1 in a short time period when the processing module 103 controls the second battery 130 to charge in the optimum service life mode.

In at least one exemplary embodiment, the processing module 103 can apply the maximum capacity mode to control the battery 12 charge or discharge when the electronic device is in the third usage pattern. For example, the processing module 103 can switch on the charge function of the first battery 120 and switch on the discharge function of the second battery 130. The processing module 103 can switch on the charge function of the second battery 130 when the SOC value of the first battery 120 is more than a first default level (e.g., 80%). The processing module 103 can switch on the discharge function of the first battery 120 when the SOC value of the second battery 130 is less than a second default level (e.g., 20%). The processing module 103 can switch on the charge function of the second battery 130 as a priority when the battery 12 is in the maximum capacity mode. It can supply 50% of electricity of the battery 12 for the electronic device 1 in a short time period when the processing module 103 switches on the charge function of the second battery 130 in the maximum capacity mode.

In at least one exemplary embodiment, the processing module 103 can apply the high output power mode to control the battery 12 charge or discharge when the electronic device is in the fourth usage pattern. For example, the processing module 103 can switch on the charge function of the first battery 120 and the second battery 130 and switch off the discharge function of the first battery 120 and the second battery 130.

In at least one exemplary embodiment, the processing module 103 can apply the quick charging mode to control the battery 12 charge or discharge when the electronic device is in the fifth usage pattern. For example, the processing module 103 can switch on the charge function of the second battery 130 and switch off the charge function and discharge function of the first battery 120, and switch off the discharge function of the second battery 130.

In at least one exemplary embodiment, the fourth usage pattern is similar to the fifth usage pattern. However, a charge rate of the battery 12 when the processing module 103 applies the high output power mode is slower than a charge rate of the battery 12 when the processing module 103 applies the quick charging mode. The quick charging mode is more suitable for the electronic device 1 when the electronic device 1 needs to charge in case of an emergency.

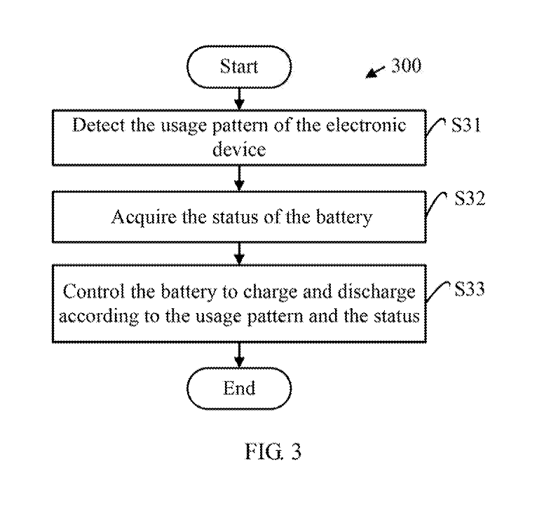

FIG. 3 illustrates a flowchart which is presented in accordance with an example embodiment. The exemplary method 300 is provided by way of example, as there are a variety of ways to carry out the method. The method 300 described below can be carried out using the configurations illustrated in FIG. 1, for example, and various elements of these figures are referenced in explaining exemplary method 300. Each block shown in FIG. 3 represents one or more processes, methods, or subroutines, carried out in the exemplary method 300. Additionally, the illustrated order of blocks is by example only and the order of the blocks can be changed according to the present disclosure. The exemplary method 300 can begin at block S31. Depending on the embodiment, additional steps can be added, others removed, and the ordering of the steps can be changed.

At block S31, the detecting module 101 can detect the usage patterns of the electronic device 1. The usage patterns can include a first usage pattern, a second usage pattern, a third usage pattern, a fourth usage pattern, and a fifth usage pattern. The controlling system 10 can apply different working mode to power the electronic device 1 by the first battery 120 and the second battery 130 when the electronic device 1 is in different usage patterns. The working modes can include a balanced mode, an optimum service life mode, a maximum capacity mode, a high output power mode, and a quick charging mode.

In at least one exemplary embodiment, in the first usage pattern, a usage rate of the electronic device 1 executes an energy-intensive application (e.g., playing video or games) is more than a first predetermined value. In the second usage pattern, duration of the electronic device 1 in sleep mode is for longer than a predetermined time (e.g., 16 hours). In the third usage pattern, the usage rate of the electronic device 1 in work mode is more than a second predetermined value. In the fourth usage pattern, a remaining power of the battery 12 of the electronic device 1 is less than a predetermined minimum value. In the fifth usage pattern, the remaining power of the battery 12 of the electronic device 1 is less than the predetermined minimum value and the electronic device 1 requires electricity in a short time period.

At block S32, the acquiring module 102 can acquire the status of the battery 12. Information as to status includes a state-of-charge (SOC) value of the first battery 120 and a SOC value of the second battery 130. The acquiring module 102 can acquire information as to the status from a sensor in the electronic device 1.

At block S33, the processing module 103 can change the working mode of the battery 12 according to the usage pattern and the status.

In at least one exemplary embodiment, the processing module 103 can switch on charge function of the first battery 120 and switch on discharge function of the second battery 130 when the SOC value of the first battery 120 is less than the SOC value of the second battery 130 and the electronic device 1 is in the first usage pattern. The processing module 103 can switch on discharge function of the first battery 120 and switch on charge function of the second battery 130 when the SOC value of the first battery 120 is equal to or more than the SOC value of the second battery 130 and the electronic device 1 is in the first usage pattern.

In at least one exemplary embodiment, the processing module 103 can control the first battery 120 and the second battery 130 to charge or discharge simultaneously when the electronic device 1 is in the second usage pattern.

In at least one exemplary embodiment, the processing module 103 can switch on the charge function of the first battery 120 and switch on the discharge function of the second battery 130 when the electronic device 1 is in the third usage pattern. The processing module 103 can switch on the charge function of the second battery 130 when the SOC value of the first battery 120 is more than the first default level and the electronic device 1 is in the third usage pattern. The processing module 103 can switch on the discharge function of the first battery 120 when the SOC value of the second battery 130 is less than the second default level and the electronic device 1 is in the third usage pattern.

In at least one exemplary embodiment, the processing module 103 can switch on the charge function of the first battery 120 and the second battery 130 simultaneously, and switch off the discharge function of the first battery 120 and the second battery 130 simultaneously when the electronic device 1 is in the fourth usage pattern.

In at least one exemplary embodiment, the processing module 103 can switch on the charge function of the second battery 130 and switch off the charge function and discharge function of the first battery 120, and switch off the discharge function of the second battery 130 simultaneously when the electronic device 1 is in the fifth usage pattern.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a battery;
a storage device; and
at least one processor;
wherein the storage device further stores one or more programs that, when executed by the at least one processor, cause the at least one processor to:
detect a usage pattern of the electronic device;
acquire a state-of-charge (SOC) value of the battery; and
control the battery to charge and discharge according to the usage pattern and the SOC value.

2. The electronic device according to claim 1, wherein the battery comprises:
a first battery, wherein a charge-discharge rate of the first battery is less than 2C (Capacity) when the electronic device is charging; and
a second battery, wherein a charge-discharge rate of the second battery is equal to or more than 2C when the electronic device is charging.

3. The electronic device according to claim 2, wherein the usage pattern comprises:
a first usage pattern, wherein a usage rate of the electronic device executes an energy-intensive application is more than a first predetermined value when the electronic device is in the first usage pattern;
a second usage pattern, wherein a duration of the electronic device in sleep mode is more than a predetermined time when the electronic device is in the second usage pattern;
a third usage pattern, wherein a usage rate of the electronic device in work mode is more than a second predetermined value when the electronic device is in the third usage pattern;
a fourth usage pattern, wherein a remaining power of the battery is less than a predetermined minimum value when the electronic device is in the fourth usage pattern; and
a fifth usage pattern, wherein the remaining power of the battery is less than the predetermined minimum value and the electronic device requires electricity in a short time period when the electronic device is in the fifth usage pattern.

4. The electronic device according to claim 3, wherein the at least one processor is further caused to:
switch on charge function of the first battery and switch on discharge function of the second battery when a SOC value of the first battery is less than a SOC value of the second battery and the electronic device is in the first usage pattern;
switch on discharge function of the first battery and switch on charge function of the second battery when the SOC value of the first battery is equal to or more than the SOC value of the second battery and the electronic device is in the first usage pattern;
switch on charge function of the first battery and the second battery or switch on discharge function of the first battery and the second battery when the electronic device is in the second usage pattern;
switch on charge function of the first battery and switch on discharge function of the second battery when the electronic device is in the third usage pattern;
switch on charge function of the second battery when the SOC value of the first battery is more than the first default and the electronic device is in the third usage pattern;
switch on discharge function of the first battery when the SOC value of the second battery is less than the second default and the electronic device is in the third usage pattern;
switch on charge function of the first battery and the second battery simultaneously, and switch off discharge function of the first battery and the second battery simultaneously when the electronic device is in the fourth usage pattern; and
switch on charge function of the second battery and switch off charge function and discharge function of the first battery, and switch off discharge function of the second battery simultaneously when the electronic device is in the fifth usage pattern.

5. A controlling method applied in an electronic device, the method comprising:
detecting a usage pattern of the electronic device;
acquiring a state-of-charge (SOC) value of a battery of the electronic device; and
controlling the battery to charge and discharge according to the usage pattern and the SOC value.

6. The method according to claim 5, wherein the battery comprises:
a first battery, wherein a charge-discharge rate of the first battery is less than 2C (Capacity) when the electronic device is charging; and
a second battery, wherein a charge-discharge rate of the second battery is equal to or more than 2C when the electronic device is charging.

7. The method according to claim 6, wherein the usage pattern comprises:
a first usage pattern, wherein a usage rate of the electronic device executes an energy-intensive application is more than a first predetermined value when the electronic device is in the first usage pattern;
a second usage pattern, wherein a duration of the electronic device in sleep mode is more than a predetermined time when the electronic device is in the second usage pattern;
a third usage pattern, wherein a usage rate of the electronic device in work mode is more than a second predetermined value when the electronic device is in the third usage pattern;
a fourth usage pattern, wherein a remaining power of the battery is less than a predetermined minimum value when the electronic device is in the fourth usage pattern; and
a fifth usage pattern, wherein the remaining power of the battery is less than the predetermined minimum value and the electronic device requires electricity in a short time period when the electronic device is in the fifth usage pattern.

8. The method according to claim 7, wherein the method is further comprising:
switching on charge function of the first battery and switching on discharge function of the second battery when a SOC value of the first battery is less than a SOC value of the second battery and the electronic device is in the first usage pattern;
switching on discharge function of the first battery and switching on charge function of the second battery when the SOC value of the first battery is equal to or more than the SOC value of the second battery and the electronic device is in the first usage pattern;
switching on charge function of the first battery and the second battery or switching on discharge function of the first battery and the second battery when the electronic device is in the second usage pattern;
switching on charge function of the first battery and switching on discharge function of the second battery when the electronic device is in the third usage pattern;
switching on charge function of the second battery when the SOC value of the first battery is more than the first default and the electronic device is in the third usage pattern;
switching on discharge function of the first battery when the SOC value of the second battery is less than the second default and the electronic device is in the third usage pattern;
switching on charge function of the first battery and the second battery simultaneously, and switching off discharge function of the first battery and the second battery simultaneously when the electronic device is in the fourth usage pattern; and
switching on charge function of the second battery and switching off charge function and discharge function of the first battery, and switching off discharge function of the second battery simultaneously when the electronic device is in the fifth usage pattern.

9. A non-transitory storage medium having stored thereon instructions that, when executed by a processor of an electronic device, causes the processor to perform a controlling method, the method comprising:
detecting a usage pattern of the electronic device;
acquiring a state-of-charge (SOC) value of a battery of the electronic device; and
controlling the battery to charge and discharge according to the usage pattern and the SOC value.

10. The non-transitory storage medium according to claim 9, wherein the battery comprises:
a first battery, wherein a charge-discharge rate of the first battery is less than 2C (Capacity) when the electronic device is charging; and
a second battery, wherein a charge-discharge rate of the second battery is equal to or more than 2C when the electronic device is charging.

11. The non-transitory storage medium according to claim 13, wherein the usage pattern comprises:
a first usage pattern, wherein a usage rate of the electronic device executes an energy-intensive application is more than a first predetermined value when the electronic device is in the first usage pattern;
a second usage pattern, wherein a duration of the electronic device in sleep mode is more than a predetermined time when the electronic device is in the second usage pattern;
a third usage pattern, wherein a usage rate of the electronic device in work mode is more than a second predetermined value when the electronic device is in the third usage pattern;
a fourth usage pattern, wherein a remaining power of the battery is less than a predetermined minimum value when the electronic device is in the fourth usage pattern; and
a fifth usage pattern, wherein the remaining power of the battery is less than the predetermined minimum value and the electronic device requires electricity in a short time period when the electronic device is in the fifth usage pattern.

12. The non-transitory storage medium according to claim 11, wherein the method is further comprising:
switching on charge function of the first battery and switching on discharge function of the second battery when a SOC value of the first battery is less than a SOC value of the second battery and the electronic device is in the first usage pattern;
switching on discharge function of the first battery and switching on charge function of the second battery when the SOC value of the first battery is equal to or more than the SOC value of the second battery and the electronic device is in the first usage pattern;
switching on charge function of the first battery and the second battery or switching on discharge function of the first battery and the second battery when the electronic device is in the second usage pattern;
switching on charge function of the first battery and switching on discharge function of the second battery when the electronic device is in the third usage pattern;
switching on charge function of the second battery when the SOC value of the first battery is more than the first default and the electronic device is in the third usage pattern;
switching on discharge function of the first battery when the SOC value of the second battery is less than the second default and the electronic device is in the third usage pattern;
switching on charge function of the first battery and the second battery simultaneously, and switching off discharge function of the first battery and the second battery simultaneously when the electronic device is in the fourth usage pattern; and
switching on charge function of the second battery and switching off charge function and discharge function of the first battery, and switching off discharge function of the second battery simultaneously when the electronic device is in the fifth usage pattern.
